(19) United States
(12) Patent Application Publication
(10) Pub. No.: US 2019/0251249 A1
(43) Pub. Date: Aug. 15, 2019

(54) Methods and Systems for Securing and Recovering a User Passphrase

(71) Applicant: Rivetz Corp., Wilmington, DE (US)

(72) Inventors: Steven Sprague, Richmond, MA (US); Alexis Sprague, Pittsfield, MA (US)

(21) Appl. No.: 16/208,167

(22) Filed: Dec. 3, 2018

Related U.S. Application Data
(60) Provisional application No. 62/597,859, filed on Dec. 12, 2017.

(51) Int. Cl. G06F 21/45; H04L 9/08; G06Q 20/08

(52) U.S. Cl. CPC G06F 21/45; H04L 9/0894; H04L 67/141; H04L 2209/38; G06Q 20/085

(57) ABSTRACT

Embodiments are direct to an improved approach for securing a passphrase, which only allows the user to provide the passphrase as a single phrase outside the trusted user device environment. The embodiments are direct to systems and methods that register a device of a user with a recovery application, including: (i) providing a passphrase for a user account and (ii) selecting friended devices configured in a trusted network of the user device. The systems and methods generate phrases or keys from the provided passphrase and divide the generated phrases or keys into sections. For each divided section, the systems and methods distribute the section to a friended device in the trusted network, where the section is stored. During an account transaction, the systems and methods retrieve the stored sections from the friended devices, and combine the retrieved sections into the user passphrase for accessing the user account.

### RELATED APPLICATIONS

This application claims the benefit of U.S. Provisional Application No. 62/597,859 filed on Dec. 12, 2017. The entire teachings of the above application are incorporated herein by reference.

### BACKGROUND

The current state of networking security forces users to remember long complex passphrases to recover their accounts and prove their identity to an online service. There are currently only a few options for storage of these passphrases. First, a user may use pen and paper to record and store a passphrase for an account. If the user wants to be extra secure, the user can call a friend (or relative) on the phone, and communicate to the friend a portion of the elements that comprise the user's passphrases (which the friend may record and store). Every time the user needs to recover the accounts, the user must retrieve the paper from storage, and may need to call the friend to retrieve the portion of the passphrase elements communicated to the friend.

Second, the user may use an external hardware vault to store the user's passphrase. For example, a vendor may enable the user to buy (e.g., for $50) an external hardware vault, which the user may use to back-up and securely store the user's passphrase keys. Every time the user needs to recover the account, the user must physically plug in the hardware vault to retrieve the stored passphrase keys. Third, the user may use email or other electronic storage to similarly store and retrieve the user's passphrase keys. However, this form of storage, as it exists today, is technically unsecure, but many users continue to use this form of storage because of its convenience.

Further, all the options described above still communicates the passphrase in its encrypted form through a computer operating system (OS), which potentially allows a hacker to steal the passphrase and create a cloned user account.

### SUMMARY

Embodiments of the present invention are direct to an improved approach for securing passphrases used to recover accounts of a user. This improved approach never allows a passphrase to exist as a single phrase outside the trusted boundary of a user's device, unless combined into the single phrase by the user. The embodiments use a form of device-based-security that securely and conveniently provides for the delivery, distribution, assertion, and display of passphrases. The device-based-security system may perform with or without a Trusted Execution Environment (TEE) present within the device's processor.

In the most simplified embodiment of the present invention, a recovery transaction occurs as follows. A user (owner) registers a device for a recovery service, which includes providing a recovery code (passphrase) for the account of the owner. As part of the registration, the device's owner selects a set of friends to each receive a portion of the recovery code. For each selected friend, the device's owner configures a device (e.g., mobile phone) associated with the selected friend (referred to as a “friended device”). The owner's device (within the TEE, if available) then generates alpha-numeric phrases or keys (e.g., 12 alpha numeric phrases or keys) from the recovery code and distributes a portion of the generated phrases or keys to each of the friended devices for storage and control. The distribution of the recovery code ensures that the entire recovery code is not recorded in one centralized place, which can be targeted by malicious actors.

When the owner later requests the recovery code, the owner's device transmits a notification, which is received and displayed on each friended device. In response, the friend associated with each friended device must select an accept option on the friended device to send their controlled portion of the recovery code to the owner's device. The owner's device must receive and combine the distributed portion of the phrases from each friended device in order to regenerate the recovery code to access the owner account.

Embodiments are directed to computer systems and methods for recovering a user passcode. The computer systems and methods register a device of a user with an application that recovers passphrases used to access user accounts. The registration includes: (i) providing a passphrase for a user account and (ii) selecting friended devices configured in a trusted network of the user device. The computer systems and methods generate, via the user device, phrases or keys from the provided passphrase. The computer systems and methods, via the user device, further divide the generated phrases or keys into a number of sections corresponding to the number of selected friended devices. For each divided section, the computer systems and methods distribute the section to a friended device in the trusted network. The computer systems and methods, by each friended device, store the distributed section at the friended device. During an account transaction, the computer systems and methods retrieve the stored sections from the friended devices, and combine the retrieved sections into the user passphrase for accessing the user account.

In example embodiments, the generated phrases or keys comprise 12-word phrases or number keys, and each divided section includes between 3-6 of the generated phrases or keys. In some embodiments, the user device generates and divides the keys or phrases within the TEE of the user device, and each friended device stores the respective divided section within the TEE of the friended device.

In some embodiments, the computer systems and methods may also re-associate a new user device to the friended devices of the trusted network. In some of these embodiments, the re-associating includes re-connecting the new device with the application and each application service configured for the user device in a single transaction. In these embodiments, the computer systems and methods may initiate a live phone call with the friended device owners and the user, and, during the call, request by the application the section of phrases or keys from each friended device owner. The computer systems and methods then read, by each friended device owner to the user in sync with the application request, the section of phrases or keys stored on the friended device of the friended device owner. Each friended device owner may read the respective section in an open call or a closed call, and a time-limit may be set for each friended device owner to read the respective section. The computer systems and methods provide, by the user, the read sections to the user device, and the user device combines the sections into the user passphrase for accessing the user account.

In other of these embodiments, the computer methods and systems execute the re-association to separately re-connect the new device with the application by live confirmation of an identified trait of the user. The identified traits may include at least one of: biometrics, voice recognition, physical pairing with a friended device or trusted network, bitcoin wallet address and keys, full user name, answers to security questions, big data identity analytics, federal identification, and social security information. The computer methods and systems, as part of the live confirmation, use a hash of the identifying trait to locate a record on a blockchain or data server.

In some embodiments, the computer systems and methods retrieve the sections of phrases or keys by at least one of the following. The computer systems and methods may perform a health or integrity check on each friended device in the trusted network. The computer systems and methods may verify: (i) by the user device, integrity of a TEE of each friended device and (ii) by each friended device, integrity of a TEE of the user device, and include the verification to indicate state of the verified device in a transmission of a section of the phrases or keys. The computer systems and methods may read, by each friended device owner, a respective section of phrases or keys in a conference call the friended device owner and the user. The computer systems and methods may view physically a section of the phrases or keys on the respective friended device.

In some embodiments, the computer systems and methods may store the distributed section by a key management application as follows. If the key management application is coupled to the blockchain, the computer systems and methods store the sections in the blockchain as an encrypted hash. If the key management application is not coupled to the blockchain, the computer systems and methods store the sections locally at the recovery server or friended device as an encrypted hash. In some embodiments, the computer systems and methods may request a fee from the user to use the recovery application in the trusted network. The fees may comprise one of a: RVT token, electronic assets, or a national currency. The computer systems and methods compensate the owners of the friended devices a percentage of the fees. In some embodiments, the computer systems and methods define a smart contract containing rules for the distribution of electronic assets of an owner of a device on the trusted network. The computer systems and methods activate the smart contract on the death of the owner to automatically distribute the electronic assets according to the smart contract.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is an example digital processing environment in which embodiments of the present invention may be implemented.

FIG. 1B is a block diagram of any internal structure of a computer/computing node.

FIG. 2 illustrates an example method and system for generating and distributing a recovery code to recover an owner's online service account in embodiments of the present invention.

FIG. 3 illustrates an example method of recovering a passphrase (recovery code) in embodiments of the present invention.

### DETAILED DESCRIPTION

A description of example embodiments follows.

The teachings of all patents, published applications and references cited herein are incorporated by reference in their entirety.

### Digital Processing Environment

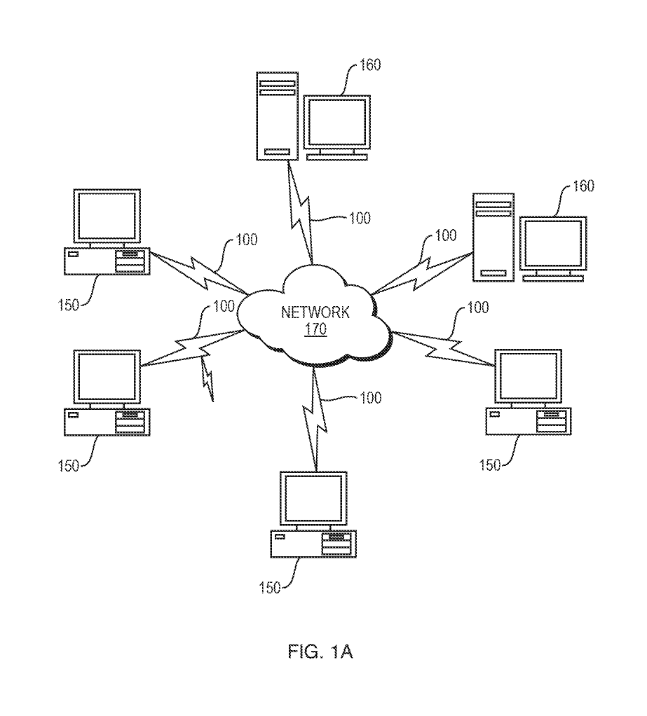

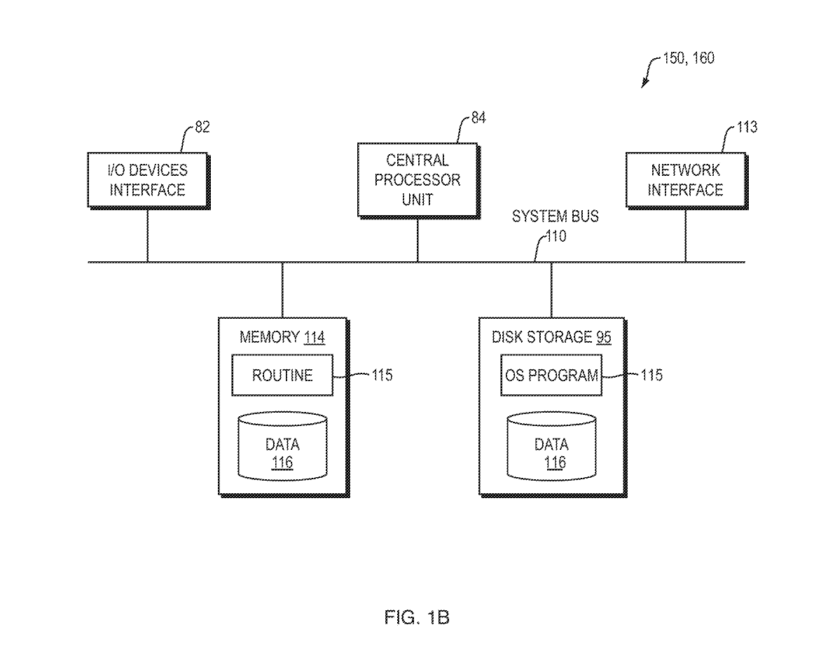

An example implementation of a recovery system 100 according to an embodiment of the invention for securing and recovering passcodes in a trusted network may be implemented in a software, firmware, or hardware environment. FIG. 1A illustrates one such example digital processing environment in which embodiments of the present invention may be implemented. Client computers/devices 150 and server computers/devices 160 (or server network 170) provide processing, storage, and input/output devices executing application programs and the like. The server computers 160 may not be separate server computers but part of a network 170.

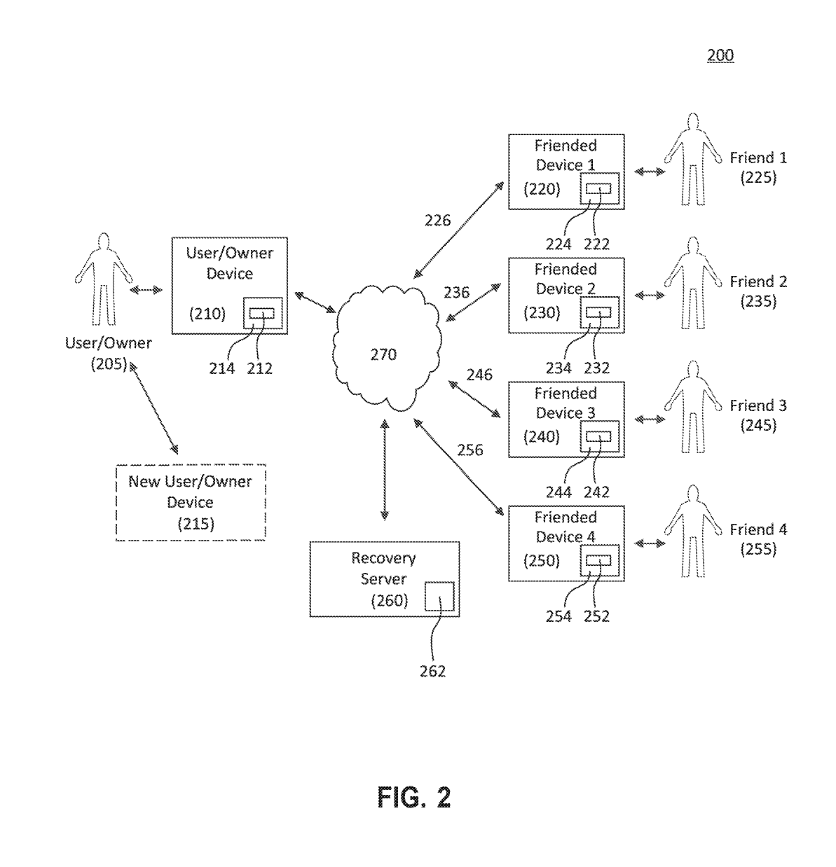

Server computers 160 may include recovery server 260 of FIG. 2, which enables a registered user (owner) 205 to execute recovery services to secure a passphrase (code) used to recover an online service account of the owner 205. The communication network 170 may also include a trusted network 270 of FIG. 2.

Client computers/devices 150 may be linked directly or through the communications network 170 to other computing devices, including other client computers/devices 150 and server computer/devices 160. The communication network 170 can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network 170 may also be a virtual private network (VPN) or an out-of-band network or both. The communication network 170 may take a variety of forms, including, but not limited to, a data network, voice network (e.g. land-line, mobile, etc.), audio network, video network, satellite network, radio network, and pager network. Other electronic device/computer networks architectures are also suitable.

Client computers/devices 150 may include the device 210 of owner 205 and the devices 220, 230, 240, 250 of trusted friends 225, 235, 245, 255 configured in the trusted network 170 of FIG. 2. The owner's device 150, in communication with the recovery server 160, generates a passphrase (code) for recovering the online service account of the owner. The device 150 is configured with a TEE where the device 150 generates keys (or phrases) from the recovery code, and distributes sections of the generated keys to the friended devices 150 to store and maintain control. The device 150, within the TEE, may later request the sections of keys from the friended devices 150 and recombine the keys to regenerate the code to recover the owner's online service account. If the owner loses the owner's device 150, the user may communicate with the recovery service to re-associate a new device with the friended devices for recovering the distributed sections of keys.

FIG. 1B is a block diagram of any internal structure of a computer/computing node (e.g., client processor/device 150 or server computers 160) in the processing environment of FIG. 1A, which may be used to facilitate displaying audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

Attached to the system bus 110 is an I/O device interface 82 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of device recovery, integrity, attestation, and authentication components of some embodiments of the present invention. Such device recovery, integrity, attestation, and authentication software components 115, 116 of the recovery system 100 (e.g. encoder, Trusted Execution Environment (TEE) applet, Trusted Application (TA), authentication site, cybersecurity controller, recovery server, service applications, and the like) described herein may be configured using any programming language, including any high-level, object-oriented programming language, such as Python.

In an example mobile implementation, a mobile agent implementation of the invention may be provided. A client server environment can be used to enable mobile security services using the server 160 (e.g., recovery server 260 of FIG. 2). It can use, for example, the XMPP protocol to tether a device authentication engine/agent 115 on the device 150 to a server 160. The server 160 can then issue commands to the mobile phone on request. The mobile user interface framework to access certain components of the system 100 may be based on XHP, Javelin and WURFL. In another example mobile implementation for OS X and iOS operating systems and their respective APIs, Cocoa and Cocoa Touch may be used to implement the client side components 115 using Objective-C or any other high-level programming language that adds Smalltalk-style messaging to the C programming language.

The system may also include instances of server processes on the server computers 160 that may comprise a recovery engine configured in a recovery server (e.g., 260 of FIG. 2), which generates a code (passphrase) for a registered user/owner to recovery online service account or any other accounts and associates (re-associates) the device of the registered owner with friended devices on a trusted network. The system may also include instances of client processes on the client computers 150 (e.g., devices 210, 220, 230, 240, 250 of FIG. 2) configured with TEE and having internal and external cybersecurity controls. The client processes on an owner device (e.g., device 210 of FIG. 2), generate keys (phrases) from the recovery code within the TEE, and distribute sections of the generated keys to the friended devices (e.g., devices 210, 220, 230, 240, 250 of FIG. 2). The client processes on the friended devices (e.g., devices 210, 220, 230, 240, 250 of FIG. 2) store and control a respective distributed section of the generated keys.

Disk storage 95 provides non-volatile storage for computer software instructions 115 (equivalently “OS program”) and data 116 used to implement embodiments of the system 100. The system may include disk storage accessible to the computers/devices 150. The computers/devices 150 can maintain secure access to sections of keys of the recovery code managed within the system 100. Central processor unit 84 is also attached to the system bus 110 and provides for the execution of computer instructions.

In an example embodiment, the processor routines 115 and data 116 are computer program products. For example, if aspects of the recovery system 100 may include both server side and client side components.

In an example embodiment, authenticators/attesters/owners/friends may be contacted via instant messaging applications, video conferencing systems, VOIP systems, email systems, etc., all of which may be implemented, at least in part, in software 115, 116. In another example embodiment, the recovery engine/service may be implemented as an application program interface (API), executable software component, or integrated component of the OS configured to authenticate users on a Trusted Platform Module (TPM) executing on a computing device 150.

Software implementations 115, 116 may be implemented as a computer readable medium capable of being stored on a storage device 95, which provides at least a portion of the software instructions for the recovery system 100. Executing instances of respective software components of the recovery system 100 may be implemented as computer program products 115, and can be installed by any suitable software installation procedure, as is well known in the art. In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present methods/systems 200 of FIG. 2.

Certain example embodiments of the invention are based on the premise that online services may be significantly enhanced when a device can be trusted to its said health and integrity and to execute instructions exactly as requested. A service provider generally has confidence in its servers because they are under administrative control and usually protected physically. However, nearly all of the service provider's services are delivered to users through devices the service provider knows very little about and over which it rarely exerts any control.

Through the use of Trusted Execution technology, certain inventive embodiments are able to provide a service provider with an oasis of trust in the unknown world of consumer devices. Basic capabilities, such as signing, key generation, and decrypting, are executed outside the unsecure environment of the main/native OS. Keys can be generated and applied without ever being exposed in memory and can be attested to through a chain of endorsements traced back to the device manufacturer.

Certain aspects of the invention enable trust in devices and health and integrity of the devices. Some embodiments operate on the fundamental premise that a reliable relationship with a device can make for a much safer, easier and stronger relationship with an end user. Achieving this requires knowing with confidence that a device involved in a current transaction is the same healthy device it was in previous transactions. It also requires assurance that a device will not leak protected information if it is requested to perform sensitive operations, such as decryption, signing, and key generation.

One example preferred embodiment includes device code executed in the Trusted Execution Environment (TEE). The TEE preferably is a hardware environment that runs small applets outside the main/native OS. This protects sensitive code and data from malware or snooping with purpose-built hardware governed by an ecosystem of endorsements, beginning with the device manufacturer.

### Generation and Distribution of Recovery Keys

FIG. 2 illustrates example method and system 200 embodiments for generating and distributing a recovery code (e.g., passphrase) to recover an owner's online service account across a trusted network. In FIG. 2, a user (owner) 205 registers a device 210 for a recovery services (via application 262 executing on recovery server 260). As part of the registration, the recovery application 262 creates a recovery code 212 for use by the device 210 of the owner 205. The owner's device 210 receives the recovery code 212 from the recovery application 262 and generates keys (phrases) from the recovery code 212. For example, the owner's device 210 may generate 12 or more keys or phrases (e.g., random words and/or numbers, such as alpha-numeric keys) from the recovery code 212. The keys of the recovery code 212 are generated within the most secure environment available on the owner's device 210, such as within its TEE or Trusted Application (TA), or within its native OS.

The owner's device 210 distributes (shares) sections or portions of the generated keys across the owner's trusted network (e.g., blockchain network) 270. The owner's trusted network 270 includes a group of devices 220, 230, 240, 250 associated with a set of friends 225, 235, 245, 255 of the owner (friended devices). Each friended device 220, 230, 240, 250 is trusted to keep its respective section of the generated keys encrypted within their most secure environments 224, 234, 244, 254, such as within their TEE/TA or native OS.

For example, as part of the registering for the recovery service/application 262, the device's owner 205 may select the set of friends 225, 235, 245, 255 to receive sections of the generated keys of the recovery code 212. For each selected friend 225, 235, 245, 255, the device's owner 205 selects the friended device 220, 230, 240, 250 associated with the selected friend 225, 235, 245, 255 in the trusted network 270. The owner's device 210 distributes a section of the generated keys of the recovery code 212 to each selected friended device 220, 230, 240, 250 over the owner's trusted network 270. For example, the owner's device 210 may distribute 12 or more generated keys of the recovery code 212 across the owner's trusted network 270 in sections of 3-6 keys per friended device 220, 230, 240, 250. Each friended device 220, 230, 240, 250 receives and securely stores their respective section 222, 232, 242, and 252 of the generated keys in their most secure environment 224, 234, 244, 254 for later access. In some example embodiments, each friended device 220, 230, 240, 250 is a node (e.g., blockchain node) of a distributed, decentralized network (e.g., blockchain network). The distribution of the sections of the generated keys ensures that the entire recovery code 212 is not recorded in one centralized place, which can be targeted by malicious actors.

In some embodiments, a primary trusted container (e.g., in the TEE or OS) 214 is configured at the owner's device 210 and multiple external trusted containers (e.g., in a respective TEE or OS) 224, 234, 244, 254 are configured at the friended devices 220, 230, 240, and 250. Multiple secure channels 226, 236, 246, 256 are arranged from the primary trusted container 214 to the multiple external trusted containers 224, 234, 244, 254 over the owner's trusted network 270. In these embodiments, within the primary trusted container 214, the owner's device 210 creates the recovery code 212 and randomly separates the recovery code into the keys and sections of keys. The owner's device 210 then transmits the sections of the keys (via a secure channel 226, 236, 246, 256) to the separate external trusted container 224, 234, 244, 254 of the friended devices 220, 230, 240, 250 for secure storage and access.

### Re-Association of Recovery Keys to New Device

FIG. 2 further illustrates example method and system 200 embodiments for re-associating a new user/owner device 215 to the recovery service/application 262 executing on recovery server (network) 260. In these embodiments, the original owner/user device 205 is lost or stolen, and, thus the owner 205 loses its list of trusted network members (friends) 225, 235, 245, 255. The following are example embodiments for the device's owner 205 to reconnect a new device 215 to the recovery application 262 executing on recovery server (network) 260.

In an example embodiment, when the owner 205 acquires the new device 215, the owner 205 must call each member (friend) 225, 235, 245, 255 of the owner's trusted network 270 to retrieve the keys of the recovery code 212. The owner 205 may call each member 225, 235, 245, 255 of the owner's trusted network 270 individually or together in a conference call to retrieve the keys. The owner 205 may then combine the retrieved keys into the recovery code 212 for accessing the owner's accounts. The owner may then use the recovery code 212 to associate the new device 215 with the recovery server 262 and re-connect all the recovery services 262 that were tied to the lost/stolen device in a single transaction.

In some embodiments, the owner may use a live voice confirmation network (e.g., part of the recovery server network 260) to request retrieval of the keys from each member 225, 235, 245, 255. For example, each member 225, 235, 245, 255 of the owner's trusted network 270 joins a conference call via the voice confirmation network, and, during the conference call, each member 225, 235, 245, 255 reads back the member's respective stored section of keys 222, 232, 242, 252 to the owner 205. In some embodiments, the conference call may be an open call, such that when one member (e.g., member 225) reads back the member's stored section of keys (e.g., section of key 222), the other members 235, 245, 255 of the trusted network 270 can hear the read section (e.g., section of keys 222). In other embodiments, the conference call is a closed call, such that the recovery server 260 automatically mutes all members of the trusted network 270, except the owner 205 of the recovery code 212. The recovery server 260 then systematically unmutes one member (e.g., member 225) and the unmuted member reads back his/her respective section of keys (e.g., section of keys 222), such the only the owner 205 hears all the read sections of keys 222, 232, 242, 252.

Further, in some embodiments, the recovery server 260 may allow each member 225, 235, 245, 255 of the trusted network 270 to enter their respective section of keys 222, 232, 242, 252 all at once. For example, key entry can be synced with the conference call, such that the recovery server 262 requests a member's respective keys (e.g., section of key 222) in sync with the member (e.g., member 225) providing the keys.

In some embodiments, the owner's new device 215 may be configured with a continue or next section button, such that if the owner 205 selects this button, the recovery server 260 transmits a current section of the keys entered by a trusted network member 225, 235, 245, 255 over the trusted network 270 to be validated at the owner's new device 215. This way, the owner 205 of the new device 215 does not need to record and transmit over the network encrypted the whole recovery code 212 in one transaction. In some embodiments, there is a time-limit set on delivering the keys over the trusted network 270, which prevents a hacker (malicious actor) from listening to the communication and later combining the transmitted keys into the recovery code 212 for accessing the accounts of the owner 205.

In some embodiments, the re-association of the new device 215 with the recovery server 260 is separate from the re-connection of the recovery services tied to the lost/stolen device 210. In these embodiments, when a user (owner) 205 creates an account with the recovery service/application 262, an identifying trait is record for the owner 205. When an owner 205 later attempts to configure a new device 215 associated to the user's account, the live confirmation network (e.g., part of the recovery server network 260) confirms, in real-time, the recorded identifying trait of the owner 205 prior to configuring the new device 215. In example embodiments, the recorded identifying trait of the owner 205 may include: biometrics, voice recognition, Bitcoin wallet addresses and keys, user's full name, answers to security questions, big data identity analytics, federal identifier information, and social network confirmation. In an example embodiment, the recorded identifying traits may also include a physical pairing with the network of trusted friended devices 220, 230, 240, 250, which is used to access sections of keys 222, 232, 242, 252 of a recovery code 212 via communication over machine-to-machine encrypted messaging channels 226, 236, 246, 256. Such access of the sections of keys ensures that no live (e.g., human) user knows the stored sections of keys. In an example embodiment, the recorded identifying traits may also include a physical pairing where a trusted network 270 enables each member (friend) 225, 235, 245, 255 to provide the sections of keys manually, via recording the sections of keys and communicating the recording to the owner (account owner) 205.

In these embodiments, the recovery server 260 or new user device 215 further generates a hash of the confirmed identifying trait of the owner 205. The recovery server 260 or new user device 215 uses the generated hash to locate a record on the blockchain or other database server that contains the list of trusted friended devices 220, 230, 240, 250 that store the sections of keys 222, 232, 242, 252 of the recovery code 212. The embodiments may use a simple identifying trait which can easily be displayed on the new owner's device 215 and stored on the blockchain, so the trait can be used to easily recover the list of friended devices 220, 230, 240, 250 storing the sections of keys 222, 232, 242, 252.

In some embodiments, for each key of the recovery code 212, an identifier for the key and a section of the key is recorded by the owner on paper. The recovery process is then reversed and verified prior to the use of the recovery key. In some embodiments, the TEE of the owner's device 210, 215 has a list of recovery devices (e.g., including recovery server 260) and randomly selects from a subset of the list (e.g., 3 out of 6 recovery devices) to transmit the key for recording on paper. The paper is then archived for later discovery and use.

In some embodiments, each member (e.g., 220) of the trusted network 270 contains a partial list of the other trusted members (e.g., 230, 240, and 250). When a re-association of the owner's new device 215 later occurs, the new device 215 can retrieve the list from a member (e.g., 220) across the trusted network 270. In some embodiments, members 220, 230, 240, 250 of the trusted network 270 automatically store their respective section of keys 222, 232, 242, 252 of the recovery code 212 to their own backup network. If one of the trusted member devices (e.g., 220) loses its respective section of keys (e.g., 222), another trusted member device (e.g., 230) can automatically recover the section of keys (e.g., 222) when their own re-association is complete. In some embodiments, a key name may be assigned to replace a key number for human readable validation and discovery.

### Retrieval of Recovery Keys

FIG. 2 further illustrates example method and system 200 embodiments for automatic retrieval of the keys of the recovery code 212 via a successful health/integrity check executed on every device 210, 220, 230, 240, 250 within the trusted network 270. In some embodiments, each external satellite container (e.g., in a respective TEE or OS) 224, 234, 244, 254 on the respective trusted device 210, 220, 230, 240, 250 verifies the integrity of the primary trusted container (e.g., in the TEE or OS) 214 on the owner's device 210 and vice versa prior to exchanging shared secret components of the keys. In addition, each device 210, 220, 230, 240, 250 append the shared secret components to transmitted integrity data to indicate the state of the device 210, 220, 230, 240, 250 that transmitted/received the shared secret components.

In some embodiments, a user 225, 235, 245, 255 of a friended device 220, 230, 240, 250 confirms retrieval of the keys within the trusted network 270 by tapping a button (e.g., an “OK” button”) on their respective device before their section of the keys 222, 232, 242, 252 is delivered to another friended device. The confirmation is used to prevent the event of someone falsely requesting the section of keys 222, 232, 242, 252 from the friended devices 220, 230, 240, 250. In some embodiments, the devices 210, 220, 230, 240, 250 (or recovery server 260) may request the retrieval of keys by including a hash of one or more security questions and an associate account number of the owner 302 in the request. In some embodiments, the devices 210, 220, 230, 240, 250 (or recovery server 260) request the retrieval of keys via an external authenticator, such as executed by voice recognition software.

In some embodiments, the devices 210, 220, 230, 240, 250 may request retrieval of the keys via a live voice confirmation network (e.g., which may be part of the recovery server network 260). Every member (friend) 205, 225, 235, 245, 255 of the trusted network 270 joins a conference call and reads back their respective section of the keys 222, 232, 242, 252 of the recovery code 212 to the owner 205. In some embodiments, the conference call may be an open call, such that when one member (e.g., member 225) reads back the member's stored section of keys (e.g., section of key 222), the other members 235, 245, 255 of the trusted network 270 can hear the read section (e.g., section of keys 222). In other embodiments, the conference call is a closed call, such that the recovery server 260 automatically mutes all members of the trusted network 270, except the owner 205 of the recovery code 212. The recovery server 260 then systematically unmutes one member (e.g., member 225) and the unmuted member reads back his/her respective section of keys (e.g., section of keys 222), such the only the owner 205 hears all the read sections of keys 222, 232, 242, 252.

Further, in some embodiments, the recovery server 260 may allow each member 225, 235, 245, 255 of the trusted network 270 to enter their respective section of keys 222, 232, 242, 252 all at once. For example, key entry can be synced with the conference call, such that the recovery server 262 requests a member's respective keys (e.g., section of key 222) in sync with the member (e.g., member 225) providing the keys.

In some embodiments, the owner's device 210 may be configured with a button (e.g., continue or next section button), such that if the owner 205 selects this button, the recovery server 260 transmits a current section of the keys entered by a trusted network member 225, 235, 245, 255 over the trusted network 270 to be validated at the owner's device 210. In this way, the owner 205 of the new device 215 does not need to record and transmit over the network 270 encrypted the whole recovery code 212 in one transaction. In some embodiments, a time-limit is set on delivering the keys over the trusted network 270, which prevents a hacker (malicious actor) from listening to the communication and later combining the transmitted keys into the recovery code 212 for accessing the accounts of the owner 205.

In some embodiments, members 225, 235, 245, 255 of the trusted network 270 must physically look at their section of the key 222, 232, 242, 252 on their friended devices 220, 230, 240, 250 of the trusted network 270. In these embodiments, the members 225, 235, 245, 255 then communicate to the owner 205 of the device 205 their keys (e.g., as characters), such as offline on a phone call, in person, or through secure electronic means of communication (which are not as secure).

### Storage of Recovery Keys

In some embodiments, the friended devices 220, 230, 240, 250 automatically store their section of keys 222, 232, 242, 252 of the recovery code 212 within the best available section 224, 234, 244, 254 of their device, such as the TEE/TA or Native OS. In example embodiments, the storing of the sections of keys 222, 232, 242, 252 by the friended devices 220, 230, 240, 250 may include physically recording a one-time (secure) recovery codes associated with the sections of keys 222, 232, 242, 252. The recovery codes are used for securely recovering the sections of keys if such recovery is ever needed.

### Management of Recovery Keys

In some embodiments, the recovery server 260 manages the keys of the recovery code 212 using the blockchain. In these embodiments, the recovery server 260 or devices 210, 220, 230, 240, 250 of the trusted network 270 store identifiers and the section of keys 222, 232, 242, 252 for each friended device 220, 230, 240, 250 in the blockchain as an encrypted hash. In some embodiments, the recovery server 260 manages the keys of the recovery code 212 without using the blockchain. In these embodiments, the recovery server 260 or devices 210, 220, 230, 240, 250 of the trusted network 270 store identifiers and the section of keys 222, 232, 242, 252 for each friended device 220, 230, 240, 250 locally (e.g., on the devices 210, 220, 230, 240, 250 or recovery server 260) as an encrypted hash.

### Consumption Model

In some embodiments, a consumption model is applied to the recovery server network 260. In these embodiments, members (friends) 225, 235, 245, 255 of the trusted network 270 are compensated a percentage of the monthly fee that the owner 205 pays to use the recovery server network 260 (and recovery services 262 executing on the server network 260). The payment to the members 225, 235, 245, 255 may be in RvT, U.S. dollars, or any other currency without limitation.

In some embodiments, the sections of keys of an owner's recovery code 212 are distributed in minute sections across the entire trusted network 270 without owner impute stored within the TA 214 of the owner's device 210 available to the recovery server network 260. These embodiments following the above consumption model by allowing members (friends) 225, 235, 245, 255 within the trusted network 270 that store a section of keys 222, 232, 242, 252 of the recovery code 212 to receive a portion of the payment (e.g., RvT or other currency) spent to maintain the recovery server network active. In some embodiments, the keys become identity keys that allow the owner 205 or members 225, 235, 245, 255 to request certification of their respective devices' status to assert to a high value service of the identity of the owner 205 or members 225, 235, 245, 255.

### Smart Contracts

In some embodiments, the recovery server 260 activates a smart contract automatically upon the death or other disabling event of a member 205, 225, 235, 245, 255. The activated smart contract enables automated distribution of electronic assets based upon the rules set by the account owner 205 in an electronic will in the form of the activated smart contract. To activate the smart contract, the recovery server network 260 must successfully retrieve and combine each section of key 222, 232, 242, 252 stored at the friended devices 220, 230, 240, 250, in addition to performing any other requirements set by the owner 205 in the smart contract. The other requirements may include, but are not limited to: a death certificate, an external party approval, social media confirmation (e.g., where bots crawl social media to confirm that the owner 205 is no longer active), a judge's approval, a passphrase provided by the owner to a trusted family member or executor, the owner's device 210, the executor's device, and such. The other requirements may also include smart biometric input (e.g., if the owner 205 has a connected heart rate monitor implant, then a connected device can confirm that the rate monitor implant is no longer active).

### Method of Recovering a Passphrase

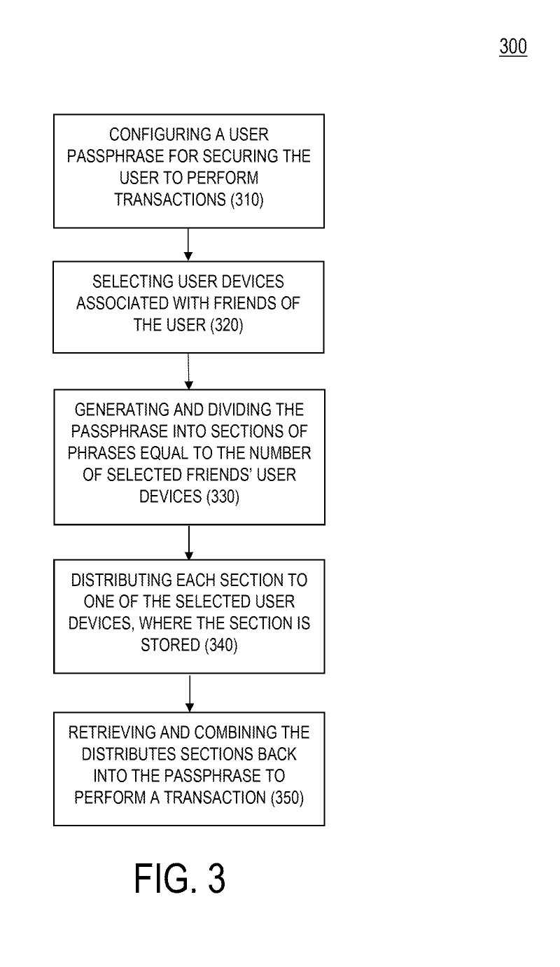

FIG. 3 is an example method 300 of recovering a passphrase in embodiments of the present invention. The method 300 begins at step 310 by a user (or owner) configuring a user passphrase (also referred to as a recovery code, code, and passcode) for securing the user to perform transactions. The passphrase is configured as part of registering a device of the user to recover an account of the user used to perform the transactions.

The method 300, at step 320, selects devices associated with friends of the user. As part of the registration, step 320 determines a set of friends to each receive a section of the passphrase (recovery code). For each determined friend, step 320 selects a device (e.g., mobile phone) associated with the determined friend to manage and store a section of the passphrase. The selected friends' devices (referred to as a “friended devices”) are configured in a trusted network (e.g., nodes on a blockchain network). In some embodiments, the selection of the friended devices may be performed within a trusted execution environment (TEE) configured on the user's device.

The method 300, at step 330, divides the configured passphrase into sections of phrases or keys (e.g., alpha-numeric phrases or keys) according to the number of selected friended devices. For example, step 330 may generate the configured passphrase into 12 alpha-numeric phrases. If step 320 selected 4 friended devices to receive a section of the passphrase, step 330 then divides the generated 12 alpha-numeric phrases into 4 sections (one for each selected friended device), each section containing 3 alpha-numeric phrases. In some embodiments, the division of the passphrase may be performed within a trusted execution environment (TEE) configured on the user's device.

The method 300, at step 340, securely distributes (over a secured channel of the trusted network) each section to one of the selected friended devices. The distribution of the sections ensures that the entire passphrase is not recorded in one centralized place, which can be targeted by malicious actors. In some embodiments, method 300 (steps 330 and 340) executes a smart contract containing rules to divide the passphrase into sections and distributes the sections to the friended devices on the trusted network. The user's device may securely store information identifying the selected friended devices, the ordering of the sections that are distributed to the selected friended devices, and such.

Each selected friended device securely stores the respective distributed section (e.g., in a format that is encrypted, signed, and the like). A selected friended device may securely store the section in a trusted container or other such memory (e.g., in the TEE) of the selected friended device. In some embodiments, step 340 stores the distributed section by a key management application. If the key management application is coupled to the blockchain, step 340 may store the sections in the blockchain as an encrypted hash. If the key management application is not coupled to the blockchain, step 340 may store the sections locally at a recovery server (as shown in FIG. 2) or friended device as an encrypted hash.

The method 300, at step 350, retrieves the distributed sections from each of the friended devices to perform a transaction using the user's account. In some embodiments, step 350 executes a smart contract containing rules to retrieve the sections from the friended devices on the trusted network. In some example embodiments, to retrieve the distributed sections, step 350 transmits a notification, which is received and displayed on each selected friended device. In response, the friend associated with each friended device must select an accept option on the friended device to send their managed section of the passphrase to the user's device. In some example embodiments, step 350 may enable reading a respective section of phrases in an open or closed conference call with the friend of a friended device and the user. In some example embodiments, step 350 may view physically a section of the phrases from the respective friended device where the section was distributed. The above section “Retrieval of Recovery Keys” describes different embodiments that may be used by step 350 to retrieve the distributed sections from the friended devices. In some embodiments, if the user's device is lost or stolen, step 350 may re-associate a new device of the user to the friended devices to retrieve the distributed sections of the passphrase, as described in the above section “Re-association of Recovery Keys to New Device.”

In some embodiments, step 350 may perform a health or integrity check on each friended device in the trusted network prior to retrieving the sections of phrases. Step 350 may verify: (i) by the user's device, integrity of a TEE of each friended device and (ii) by each friended device, integrity of a TEE of the user device. Step 350 may then include the results of the verification in a transmission of the distributed section of the phrases to indicate the current state of the respective friended device or user device. Example methods for performing such a health or integrity check are described in U.S. patent application Ser. No. 15/074,784, which is incorporated herein by reference in its entirety.

The method 300, at step 350, then combines the retrieved sections back into the passphrase to recover the user account to perform the transaction. In some embodiments, the method 300 may use stored information identifying the ordering of the sections that were distributed to the selected friended devices to combine the sections. In some embodiments, the combination of the retrieved sections may be performed within a trusted execution environment (TEE) configured on the user's device.

In some embodiments, the method 300 may request a fee from the user to use the method 300 (implemented as a recovery application) in the trusted network. The fees may comprise one of a: RVT token, electronic assets, or a national currency. The method 300 may compensate the owners of the friended devices a percentage of the fees.

While example embodiments have been particularly shown and described, it will be understood by those skilled in the art that various changes in form and details may be made therein without departing from the scope of the embodiments encompassed by the appended claims.

What is claimed is:

1. A computer-implemented method of recovering a user passphrase, the method comprising:
registering a device of a user with an application that recovers passphrases used to access user accounts, the registering includes: (i) providing a passphrase for a user account and (ii) selecting friended devices configured in a trusted network of the user device;
generating phrases or keys from the provided passphrase;
dividing the generated phrases or keys into a number of sections corresponding to the number of selected friended devices;
for each divided section, distributing the section to a friended device in the trusted network, wherein storing the distributed section at the friended device; and
during an account transaction, retrieving the stored sections from the friended devices, and combining the retrieved sections into the user passphrase for accessing the user account.

2. The method of claim 1, wherein the generated phrases or keys comprise 12-word phrases or number keys, and each divided section includes between 3-6 of the generated phrases or keys.

3. The method of claim 1, wherein the user device generates and divides the keys or phrases within the TEE of the user device, and each friended device stores the respective divided section within the TEE of the friended device.

4. The method of claim 1, further comprising re-associating a new user device to the friended devices of the trusted network.

5. The method of claim 4, wherein the re-associating includes re-connecting the new device with the application and each application service configured for the user device in a single transaction, by:
initiating a live phone call with the friended device owners and the user, wherein requesting by the application in the phone call the section of phrases or keys from each friended device owner;
reading, by each friended device owner to the user in sync with the application request, the section of phrases or keys stored on the friended device of the friended device owner, wherein each friended device owner reads the respective section in an open call or a closed call, and wherein a time-limit being set for each friended device owner to read the respective section; and
providing, by the user, the read sections to the user device, wherein the user device combining the sections into the user passphrase for accessing the user account.

6. The method of claim 4, wherein the re-associate separately re-connects the new device with the application by live confirmation of an identified trait of the user, the identified traits including at least one of: biometrics, voice recognition, physical pairing with a friended device or trusted network, bitcoin wallet address and keys, full user name, answers to security questions, big data identity analytics, federal identification, and social security information, wherein the live confirmation uses a hash of the identifying trait to locate a record on a blockchain or data server.

7. The method of claim 1, wherein retrieval of the sections of phrases or keys comprises at least one of:
performing a health or integrity check on each friended device in the trusted network;
verifying, (i) by the user device, integrity of a TEE of each friended device and (ii) by each friended device, integrity of a TEE of the user device, and including the verification to indicate state of verified device in a transmission of a section of the phrases or keys;
reading, by each friended device owner, a respective section of phrases or keys in a conference call the friended device owner and the user;
viewing physically a section of the phrases or keys on the respective friended device.

8. The method of claim 1, wherein further storing the distributed section in a key management application by one of:
if the key management application is coupled to the blockchain, storing the sections in the blockchain as an encrypted hash; and
if the key management application is not coupled to the blockchain, storing the sections locally at the recovery server or friended device as an encrypted hash.

9. The method of claim 1, further comprising:
request a fee from the user to use the recovery application in the trusted network, wherein the fees comprise one of a: RVT token, electronic assets, or a national currency; and
compensating the owners of the friended devices a percentage of the fees.

10. The method of claim 1, further comprising:
defining a smart contract containing rules for the distribution of electronic assets of an owner of a device on the trusted network;
activating the smart contract on the death of the owner to automatically distribute the electronic assets according to the smart contract.

11. A computer system for recovering a user passphrase, the system comprising:
a user device configured to:
register with an application that recovers passphrases used to access user accounts, the registering includes: (i) providing a passphrase for a user account and (ii) selecting friended devices configured in a trusted network of the user device;
generate phrases or keys from the provided passphrase;
divide the generated phrases or keys into a number of sections corresponding to the number of selected friended devices; and
for each divided section, distributing the section to a friended device in the trusted network; and
the friended devices each configured to:
receive and store the distributed section at the friended device; and
the user device further configured to:
during an account transaction, retrieve the stored sections from the friended devices, and combining the retrieved sections into the user passphrase for accessing the user account.

12. The system of claim 11, wherein the generated phrases or keys comprise 12-word phrases or number keys, and each divided section includes between 3-6 of the generated phrases or keys.

13. The system of claim 11, wherein the user device further configured to generate and divide the keys or phrases within the TEE of the user device, and each friended device further configured to store the respective divided section within the TEE of the friended device.

14. The system of claim 11, further comprising a recovery server configured to re-associate a new user device to the friended devices of the trusted network.

15. The system of claim 14, wherein the re-associating by the recovery server includes re-connecting the new device with the application and each application service configured for the user device in a single transaction, the recovery server configured to:
initiate a live phone call with the friended device owners and the user, wherein requesting by the application in the phone call the section of phrases or keys from each friended device owner;
read, by each friended device owner to the user in sync with the application request, the section of phrases or keys stored on the friended device of the friended device owner, wherein each friended device owner reads the respective section in an open call or a closed call, and wherein a time-limit being set for each friended device owner to read the respective section; and
provider, by the user, the read sections to the user device, wherein the user device combining the sections into the user passphrase for accessing the user account.

16. The system of claim 14, wherein the re-associate by the recovery server separately re-connects the new device with the application by live confirmation of an identified trait of the user, the identified traits including at least one of: biometrics, voice recognition, physical pairing with a friended device or trusted network, bitcoin wallet address and keys, full user name, answers to security questions, big data identity analytics, federal identification, and social security information, wherein the live confirmation uses a hash of the identifying trait to locate a record on a blockchain or data server.

17. The system of claim 11, wherein retrieval of the sections of phrases or keys comprises at least one of:
performing a health or integrity check on each friended device in the trusted network;
verifying, (i) by the user device, integrity of a TEE of each friended device and (ii) by each friended device, integrity of a TEE of the user device, and including the verification to indicate state of verified device in a transmission of a section of the phrases or keys;
reading, by each friended device owner, a respective section of phrases or keys in a conference call the friended device owner and the user;
viewing physically a section of the phrases or keys on the respective friended device.

18. The system of claim 11, wherein further storing the distributed section in a key management application by one of:
if the key management application is coupled to the blockchain, storing the sections in the blockchain as an encrypted hash; and
if the key management application is not coupled to the blockchain, storing the sections locally at the recovery server or friended device as an encrypted hash.

19. The system of claim 11, further configured to:
request a fee from the user to use the recovery application in the trusted network, wherein the fees comprise one of a: RVT token, electronic assets, or a national currency; and
compensate the owners of the friended devices a percentage of the fees.

20. The system of claim 11, further configured to:
define a smart contract containing rules for the distribution of electronic assets of an owner of a device on the trusted network;
activate the smart contract on the death of the owner to automatically distribute the electronic assets according to the smart contract.

21. A computer program product comprising:
a non-transitory computer-readable storage medium having code instructions stored thereon, the storage medium operatively coupled to a processor such that, when executed by the processor, the computer code instructions cause the processor to:
register a device of a user with an application that recovers passphrases used to access user accounts, the registering includes: (i) providing a passphrase for a user account and (ii) selecting friended devices configured in a trusted network of the user device;
generate phrases or keys from the provided passphrase;
divide the generated phrases or keys into a number of sections corresponding to the number of selected friended devices;
for each divided section, distribute the section to a friended device in the trusted network, wherein storing the distributed section at the friended device; and
during an account transaction, retrieve the stored sections from the friended devices, and combining the retrieved sections into the user passphrase for accessing the user account.
